(19) United States
(12) Patent Application Publication
(10) Pub. No.: US 2022/0099091 A1
(43) Pub. Date: Mar. 31, 2022

(54) COMPRESSOR INCLUDING LASER-HARDENED BEARING SURFACES

(71) Applicant: TRANE INTERNATIONAL INC., Davidson, NC (US)

(72) Inventors: Christopher A. Wehrenberg, La Crosse, WI (US); William E. Lapp, La Crosse, WI (US)

(21) Appl. No.: 17/039,552

(22) Filed: Sep. 30, 2020

(51) Int. Cl. F04C 18/02

(52) U.S. Cl. CPC F04C 18/0215; F04C 2230/41; F04C 2230/60; F04C 2240/50

(57) ABSTRACT

This disclosure is directed to compressors with hardened bearing surfaces, particularly laser-hardened bearing surfaces. Laser hardening can be used to precisely harden selected areas of the bearing surfaces of the compressor components. By hardening those selected areas, wear resistance can be improved and sliding wear can be reduced. This can result in thrust plates having different material structures configured to contact one another, such as one having a primarily pearlitic microstructure with the opposing thrust plate having a primarily martensitic microstructure. This can reduce adhesive wear by providing dissimilarity on the wearing surfaces.

### FIELD

This disclosure is directed to compressors with hardened bearing surfaces, particularly laser-hardened bearing surfaces.

### BACKGROUND

Bearings in compressors for heating, ventilation, air conditioning, and refrigeration (HVACR) systems are typically lubricated by the working fluid or a lubricant included in the working fluid. The compressor can reach a dry state where the lubricant migrates, and vapor can even further remove residual lubricant from the bearing surfaces. This can occur, for example, when a compressor is in an off state. When started in such a dry state, the compressor can be damaged by wear, such as adhesive and abrasive wear among the components during the dry start.

### SUMMARY

This disclosure is directed to compressors with hardened bearing surfaces, particularly laser-hardened bearing surfaces.

Laser hardening can be used to precisely harden selected areas of the bearing surfaces of the compressor components. By hardening those selected areas, wear resistance can be improved and sliding wear can be reduced. This can result in thrust plates having different material structures configured to contact one another, where one thrust plate has a relatively soft surface, for example a surface that includes one or more of a pearlitic structure, carbon, nickel, manganese phosphate, or fluoropolymer coatings, and for example where the opposing thrust plate has a laser-hardened surface including a martensitic microstructure. This can reduce adhesive wear by providing dissimilarity on the wearing surfaces.

In an embodiment, a compressor includes a housing including a fixed scroll member, a stationary supporting structure, and an orbiting scroll member; and a thrust bearing disposed between the housing and the orbiting scroll member in an axial direction of the orbiting scroll member. The thrust bearing has a first thrust plate with a first wearing surface and a second thrust plate with a second wearing surface opposing the first wearing surface, and one of the wearing surfaces has a laser hardened layer including a martensitic structure opposing the other one of the wearing surfaces. The laser hardened layer including the martensitic structure has a thickness of between at or about 0.4 mm and at or about 1.5 mm with the one of the wearing surfaces having the laser hardened layer including the martensitic structure. The laser hardened layer including the martensitic structure has a hardness of at least 400 Knoop hardness (HK). The other one of the wearing surfaces includes a pearlitic microstructure. The first thrust plate is installed or integrated into the housing, and the second thrust plate is installed or integrated into the orbiting scroll member. The wearing surfaces contact one other when the compressor is not in operation.

In an embodiment, an HVACR system includes a compressor, a condenser, an expander, and an evaporator. The compressor includes a housing including a fixed scroll member, a stationary supporting structure, an orbiting scroll member. A thrust bearing is disposed between the stationary supporting structure of the housing and the orbiting scroll member in an axial direction of the orbiting scroll member. The thrust bearing has a first thrust plate with a first wearing surface and a second thrust plate with a second wearing surface opposing the first wearing surface. One of the wearing surfaces has a laser hardened layer including a martensitic structure opposing the other one of the wearing surfaces. The laser hardened layer including the martensitic structure has a thickness of between at or about 0.4 mm and at or about 1.5 mm with the one of the wearing surfaces having the laser hardened layer including the martensitic structure. The laser hardened layer including the martensitic structure has a hardness of at least 400 HK. The other one of the wearing surfaces has a pearlitic microstructure. The first thrust plate is installed or integrated into the housing, and the second thrust plate is installed or integrated into the orbiting scroll member. The wearing surfaces contact one other when the compressor is not in operation.

In an embodiment, a method of manufacturing a scroll compressor with a wearing resistant thrust bearing includes providing a housing including a stationary supporting structure with a first thrust plate and a first wearing surface of a thrust bearing, providing an orbiting scroll member with a second thrust plate and a second wearing surface of the thrust bearing positioned opposing the first wearing surface when the compressor is assembled, laser treating one of the wearing surfaces, quenching the one of the wearing surfaces by a mass of the thrust plate of which the one of the wearing surfaces that is laser treated, producing a laser hardened layer including a martensitic structure opposing the other one of the wearing surfaces, tempering the thrust plate of which the one of the wearing surfaces is laser treated, and assembling the stationary supporting structure and the orbiting scroll member so that the first wearing surface of the first thrust plate opposes the second wearing surface of the second thrust plate forming the thrust bearing between the stationary supporting structure and the orbiting scroll member of the compressor.

The laser hardened layer including the martensitic structure has a thickness of between at or about 0.4 mm and at or about 1.5 mm with the one of the wearing surfaces having the laser hardened layer including martensitic structure. The laser hardened layer including the martensitic structure has a hardness of at least 400 HK. The method further includes measuring the hardness of the laser hardened layer including the martensitic structure using an average of a plurality of readings. The other of the wearing surfaces includes pearlitic microstructure. The first thrust plate is installed or integrated into the housing, and the second thrust plate is installed or integrated into the orbiting scroll member. The wearing surfaces contact one other when the compressor is not in operation.

### DRAWINGS

FIG. 1 shows a schematic diagram of an HVACR system according to an embodiment.

FIG. 2 shows a sectional view of a vertical, single-stage scroll compressor according to an embodiment.

FIG. 3 shows an enlarged sectional view of a wearing resistant thrust bearing according to an embodiment.

FIG. 4A shows a bottom view of the orbiting scroll according to an embodiment.

FIG. 4B shows a top of the stationary supporting structure.

FIG. 5 is a flowchart for a method of manufacturing a wear-resistant thrust bearing according to an embodiment.

FIG. 6 shows an Oldham coupling for a scroll compressor according to an embodiment.

FIG. 7 shows an orbiting scroll configured to be used with an Oldham coupling in a scroll compressor according to an embodiment.

FIG. 8 shows a fixed scroll configured to be used with an Oldham coupling in a scroll compressor according to an embodiment.

Like reference numbers represent like parts throughout.

### DETAILED DESCRIPTION

This disclosure is directed to compressors with hardened bearing surfaces, particularly laser-hardened bearing surfaces.

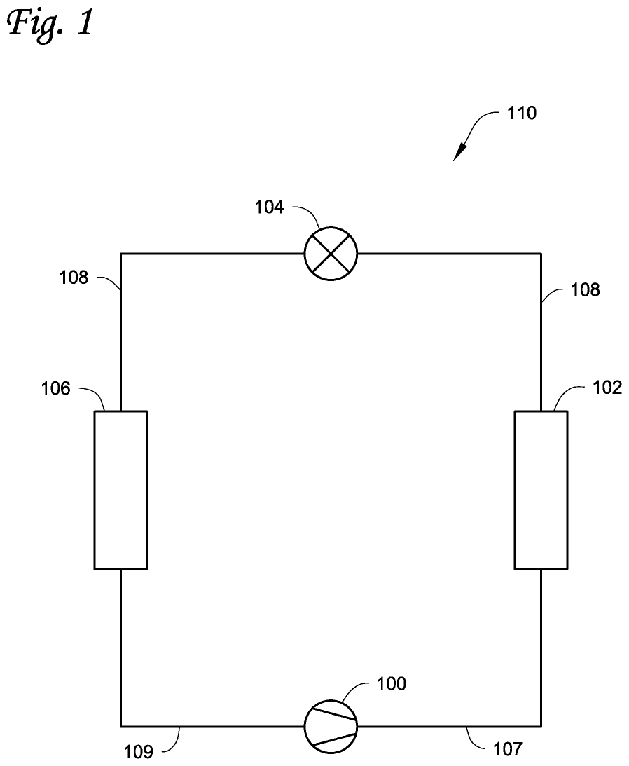

FIG. 1 is a schematic diagram of an HVACR system 110, according to an embodiment. The HVACR system 110 includes a compressor 100, a condenser 102, an expander 104, and an evaporator 106.

The HVACR system 110 is an example that is modifiable to include additional components. For example, in an embodiment, the HVACR system 110 can include other components such as, but not limited to, an economizer heat exchanger, one or more flow control devices, a receiver tank, a dryer, one or more additional heat exchangers, or the like.

The HVACR system 110 is generally applicable in a variety of systems used to control an environmental condition (e.g., temperature, humidity, air quality, or the like) in a space (generally referred to as a conditioned space). Examples of such systems include, but are not limited to, residential, commercial, or industrial HVACR systems, transport refrigeration systems, or the like.

The HVACR system 110 includes the compressor 100, condenser 102, expander 104, and evaporator 106 fluidly connected via refrigerant lines 107, 108, and 109. In an embodiment, the refrigerant lines 107, 108, and 109 can alternatively be referred to as the refrigerant conduits 107, 108, and 109, or the like.

In an embodiment, the HVACR system 110 is configured to be a cooling system (e.g., an air conditioning system) capable of operating in a cooling mode. In an embodiment, the HVACR system 110 is configured to be a heat pump system that can operate in both a cooling mode and a heating/defrost mode.

The HVACR system 110 can operate according to generally known principles. The HVACR system 110 can be configured to heat or cool a process fluid (e.g., a heat transfer medium or fluid such as, but not limited to, water, air or the like), in which case the HVACR system 110 may be generally representative of an air conditioner or heat pump.

In operation, the compressor 100 compresses a working fluid (e.g., a heat transfer fluid such as a refrigerant or the like) from a relatively lower pressure gas (e.g., suction pressure) to a relatively higher-pressure gas (e.g., discharge pressure). In an embodiment, the compressor 100 can be a positive displacement compressor. In an embodiment, the positive displacement compressor can be a screw compressor, a scroll compressor, a reciprocating compressor, or the like.

The relatively higher-pressure gas is also at a relatively higher temperature, which is discharged from the compressor 100 and flows through refrigerant line 107 to the condenser 102. The working fluid flows through the condenser 102 and rejects heat to a process fluid (e.g., water, air, or the like), thereby cooling the working fluid. The cooled working fluid flows to the expander 104 via the refrigerant line 108. In an embodiment, the expander 104 can be an expansion valve, expansion plate, expansion vessel, orifice, or the like, or other suitable types of expansion mechanisms. It is to be appreciated that the expander may be any type of expander used in the field for expanding a working fluid to cause the working fluid to decrease in temperature and pressure.

The expander 104 reduces the pressure of the working fluid. The working fluid flows to the evaporator 106 via the refrigerant line 108. The working fluid flows through the evaporator 106, where it absorbs heat from a process fluid (e.g., water, air, or the like), heating the working fluid. The heated working fluid then returns to the compressor 100 via the refrigerant line 109. The above-described process continues while the HVACR system is operating, for example, in a cooling mode (e.g., while the compressor 100 is enabled).

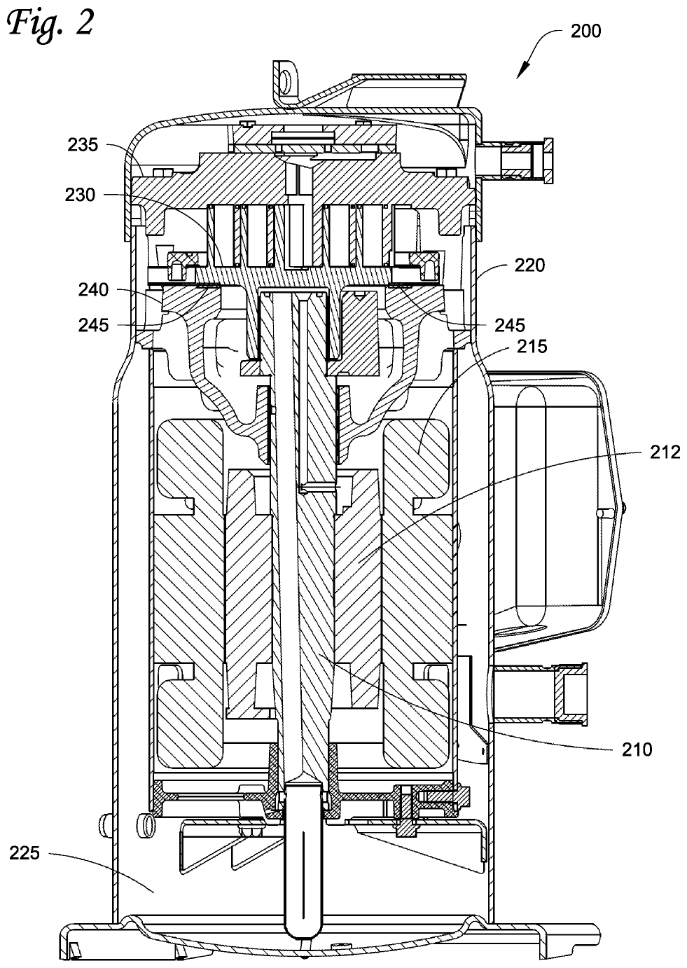

FIG. 2 illustrates a scroll compressor according to an embodiment. It is to be appreciated that the embodiments as disclosed herein may be used with other types of compressors, such as, for example, other types of scroll compressors, a screw compressor, a reciprocating compressor and other suitable types of compressors, including hermetic compressors. The embodiments as disclosed herein are suitable for compressors having contacting surfaces.

The scroll compressor 200 includes a housing 220. The crankshaft 210 is coupled to a rotor 212. The rotor 212 is surrounded by a stator 215. The crankshaft 210 is coupled to an orbiting scroll member 230 that is intermeshed with a fixed scroll member 235 to compress, for example, a working fluid of an HVACR system. The housing 220 also includes a lubricant sump 225 that may contain a lubricant.

The orbiting scroll member 230 is positioned vertically or near vertically in the orientation as shown in FIG. 2. In the vertical direction, the orbiting scroll member 230 is partially supported by a stationary supporting structure 240 of the housing 220. The orbiting scroll member 230 and the stationary supporting structure 240 are separated by a thrust bearing 245. In an embodiment, the stationary supporting structure 240 is a bearing housing.

In operation, the stator 215 and the rotor 212 can create a relative motion, which is transmitted to the crankshaft 210. The crankshaft 210 can then drive the orbiting scroll member 230 to intermesh with the fixed scroll member 235 and compress, for example, a working fluid of an HVACR system.

The thrust bearing 245 may withstand axial thrust loads in the vertical direction. The axial thrust load may be created by, for example, a weight of the orbital scroll member 230. The axial thrust load may also be created by, for example, a pressure differential between the scroll mechanism (e.g. orbiting scroll member 230) and sump 225 of the housing 220. The axial thrust load may increase friction between the crankshaft 210 and the thrust bearing 245, consequently causing wears of the thrust bearing 245. Further, wearing of the thrust bearing 245 may be created by sliding wear. More specifically, sliding wear can be created by adhesion, abrasion, or both.

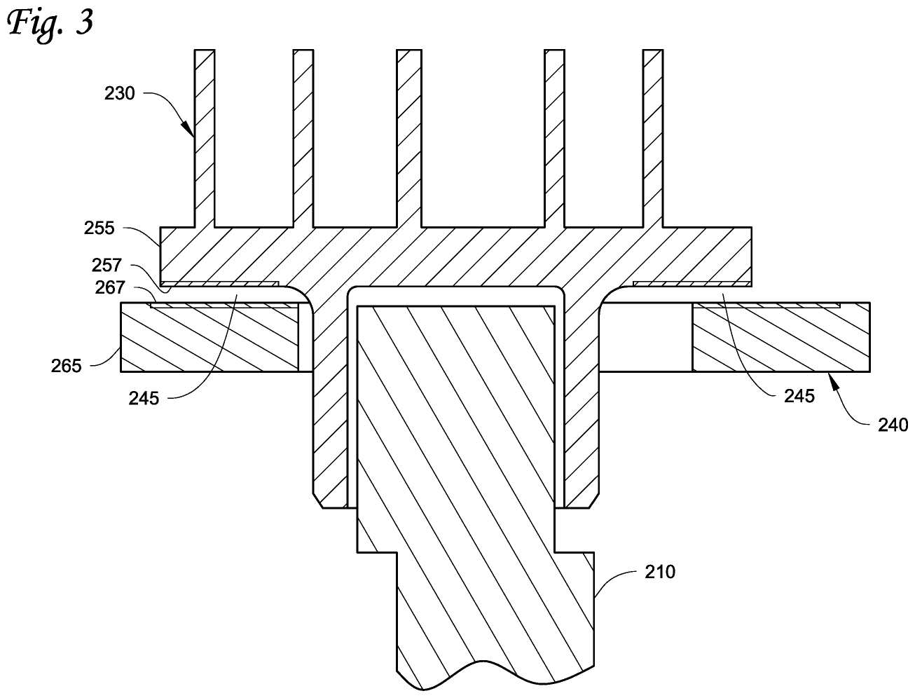

FIG. 3 is an enlarged view of a portion of the compressor 200 to illustrate the structure of the thrust bearing 245 according to an embodiment. As illustrated in FIG. 3, the thrust bearing 245 includes a first thrust plate 255 and a second thrust plate 265 separated axially by a lubricant during operation of the compressor 200. The first and second wearing surfaces 257 and 267 are opposing each other. In an embodiment, the first and second thrust plates 255 and 265 are made predominantly of a gray iron or steel material having a primarily pearlitic microstructure.

According to an embodiment, one of the first wearing surface 257 or the second wearing surfaces 267 is treated with a laser for a predetermined period of time, achieving a predetermined temperature at a predetermined depth. The one of the first and second wearing surfaces 257 and 267 becomes a treated wearing surface. The other one of the first and second wearing surface 257 and 267 is an untreated wearing surface. The predetermined depth is relatively shallow compared with a thickness of the thrust plate of the treated wearing surface. Due to the relatively shallow depth, the treated wearing surface is self-quenching and forms a layer including a primarily martensitic microstructure onto a layer of generally pearlitic microstructure. The self-quenching can be achieved by, for example, treating a relatively shallow layer compared with the thickness of the thrust plate so that the thrust plate can rapidly absorb the heat generated from the laser treatment, and rapid cooling of the treated surface as a result. The other one of the first and second wearing surfaces 257 and 267 is untreated, having a primarily pearlitic microstructure at the wearing surface. In embodiments, the other of the first and second wearing surfaces 257 and 267 can include a relatively soft surface, for example, iron including primarily pearlitic structure, carbon, nickel, manganese phosphate, fluoropolymer coatings, or the like opposite the laser treated wearing surface 257 or 267.

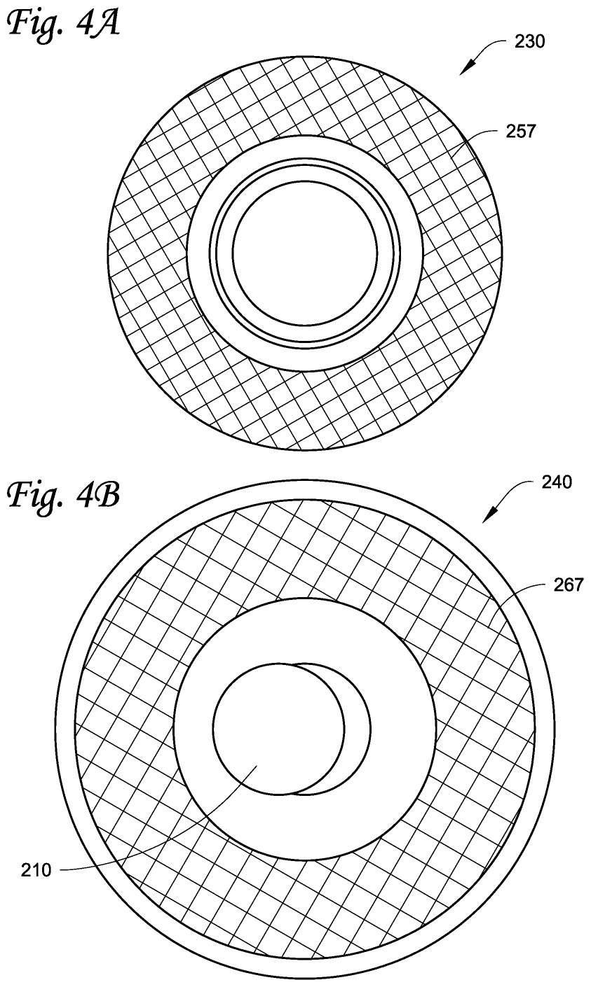

FIG. 4A shows a bottom view of the orbiting scroll member 230. FIG. 4B shows a top view of the stationary supporting structure 240 and the crankshaft 210. The first wearing surface 257 has a first ring shape, and the second wearing surface 267 has a second ring shape. The first ring shape fits within the second ring shape so that the second wearing surface 267 is substantially opposing the first wearing surface 257 when the first wearing surface is orbiting as a part of the orbiting scroll member 230.

During operation of the compressor 200, the crankshaft 210 drives the orbiting scroll member 230 to orbit in relationship to the fixed scroll member 235 and the stationary supporting structure 240. A lubricant is pumped into the thrust bearing 245 and separates the first wearing surface 257 and the second wearing surface 267. When the compressor 230 stops, the lubricant is no longer being pumped to the thrust bearing 245, and begins to be removed from the thrust bearing 245.

When the compressor 200 is not in operation, a lubricant begins to be removed from the thrust bearing 245 because the refrigerant may migrate into the thrust bearing 245 and vapor degrease the lubricant. Over a period of time of no operation, the first and second wearing surfaces 257 and 267 will be in contact due to the lack of lubrication.

According to an embodiment, when the compressor starts after the lubricant has been removed, the compressor experiences a dry start. A dry start is when a compressor starts after a thrust bearing has been degreased, and before the lubricant has been replenished at the thrust bearing. Within the thrust bearing, a wearing surface of a thrust plate of an orbiting member of the compressor starts to orbit about a wearing surface of a thrust plate on a fixed scrolling member without sufficient lubricant therebetween. As a result, the first and second wearing surfaces are in direct contact, and experience sliding wear. Such sliding wear can include adhesive and/or abrasive wear.

Adhesive wear occurs when the first and second wearing surface are made of the same material and are sliding without lubrication resulting in asperities due to friction welding together. Very soon after the friction welding, the torque from a crankshaft driving the orbital motion of the orbiting scroll member can shear off friction welded asperities, causing adhesive wearing.

Abrasive wear can follow when sheared off welded asperities become small abrasive particles between the first and second wearing surfaces. While in operation, the sliding between the first and second wearing surface can experience abrasive wearing due to the presence of these small particles.

Laser treating one of the first and second wearing surface forms a treated wearing surface. The other one of the first and second wearing surfaces is an untreated wearing surface. The treated wearing surface has a primarily martensitic microstructure while the untreated wearing surface can include primarily a pearlitic microstructure. Optionally, a relatively soft wearing surface can be provided opposite the treated wearing surface, such as carbon, nickel, manganese phosphate, or a fluoropolymer.

Sliding wearing between the treated and untreated wearing surfaces is reduced including both adhesive wearing and abrasive wearing. Adhesive wearing is reduced because different microstructures have dissimilar chemical properties making friction welding more difficult. Consequently, abrasive wearing is reduced for two reasons. First, reduced friction welding results in a reduced amount of abrasive particles being produced by shearing between treated and untreated wearing surfaces. Second, the treated wearing surface has a primarily martensitic microstructure that is more wear resistant than a primarily pearlitic microstructure from before the laser treatment, and thus the treated wearing surface is also less susceptible to wear.

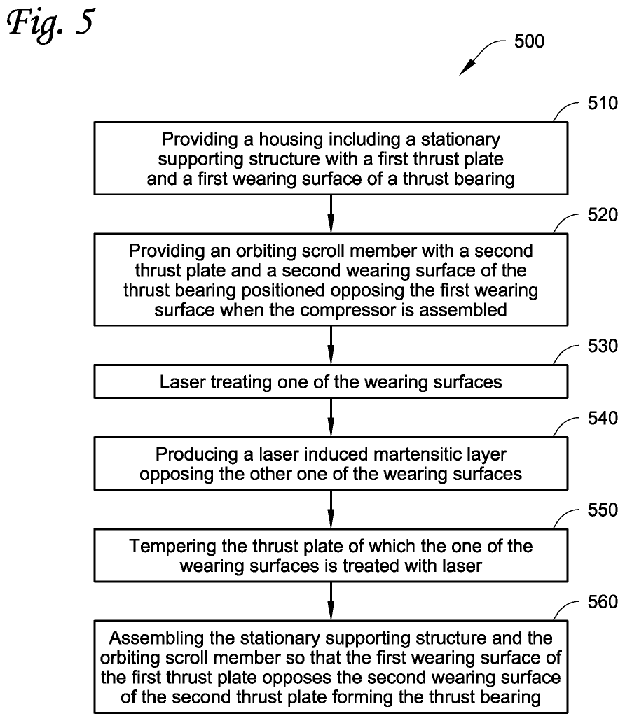

FIG. 5 is a flowchart illustrates a method for manufacturing a wearing resistant thrust bearing for a compressor 500. The compressor can be a vertical or a horizontal compressor. In an embodiment, the compressor is a vertical scroll compressor.

The method includes providing a housing that includes a stationary supporting structure with a first thrust plate and a first wearing surface of a thrust bearing 510.

The method further includes providing an orbiting scroll member with a second thrust plate and a second wearing surface of the thrust bearing positioned opposing the first wearing surface when the compressor is assembled 520. The orbiting scroll member intermeshes with the fixed scroll member to compress, for example, a working fluid of an HVACR system.

The method further includes laser treating one of the first and second wearing surfaces 530. According to an embodiment, laser can heat the one of first and second wearing surfaces for a predetermined period of time at a predetermined intensity. The laser moves in a pattern that covers an area of the one of the first and second wearing surfaces that opposes the other one of the first and second wearing surfaces when assembled. In another embodiment, the laser treatment covers a substantial portion, such as, for example, over 50% of the wearing surface that opposes the other wearing surface when assembled.

The method further includes quenching the one of the first and second wearing surfaces. In one embodiment, quenching is accomplished by a mass of the thrust plate of the treated wearing surface.

The method further includes producing a laser hardened layer including martensitic structure opposing the other first and second wearing surfaces 540. The laser hardened layer including martensitic structure having a hardness of at least 400 HK. The laser hardened layer including martensitic structure has a thickness of between at or about 0.4 mm and at or about 1.5 mm with the one of the wearing surfaces having the laser hardened layer including martensitic structure. The thickness can be a nominal thickness such as a depth setting for the laser hardening tool. It is understood that the thickness can vary from these nominal values due to manufacturing variances, ambient conditions during hardening or quenching, or any other such source of variance. A hardness of the laser hardened layer including martensitic structure is measured using an average of a plurality of readings. The method further includes tempering the thrust plate 550 treated with laser at a predetermined temperature. In one embodiment, the predetermined temperature is at or about 400 degree Fahrenheit.

Laser treatment of a wearing surface, compared with conventional heat treating process, introduces a smaller amount of heat and results in a lesser amount of distortion due to the treatment. Thus, laser treatment, compared with conventional heat treatment of the entire thrust plate, reduces the manufacturing cost to correct the distortion after heat treatment. Alternatively, a wear resistance wearing surface can be produced by coating or cladding onto the wearing surface which are more expensive.

The method further includes assembling the stationary supporting structure and the orbiting scroll member so that the first wearing surface of the first thrust plate opposes the second wearing surface of the second thrust plate forming a thrust bearing between the stationary supporting structure and the orbiting scroll member of the compressor 560.

In an embodiment, laser hardening can be applied to surfaces in an Oldham coupling that is used between the orbiting and fixed scrolls. The Oldham coupling is placed between the orbiting and fixed scrolls to constrain relative rotation and ensure movement of the scrolls relative to one another is primarily the orbiting motion.

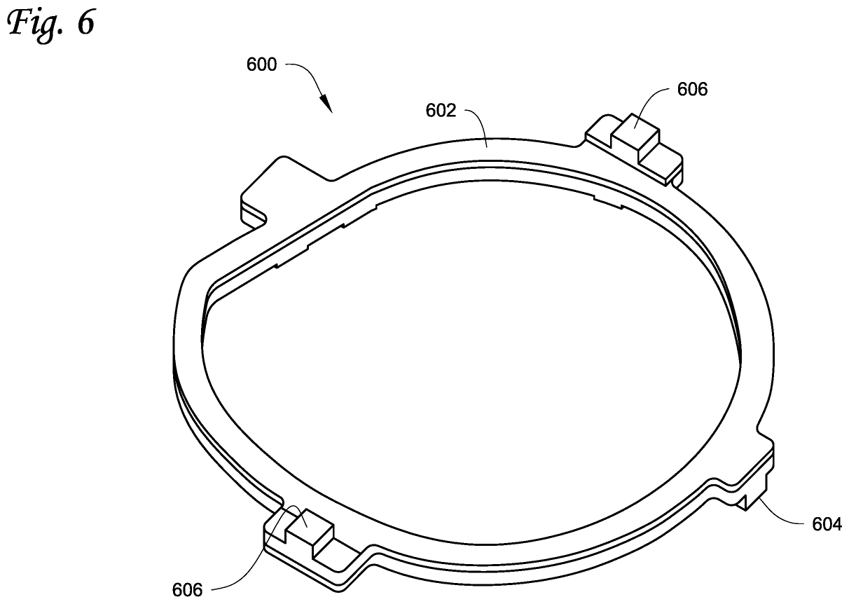

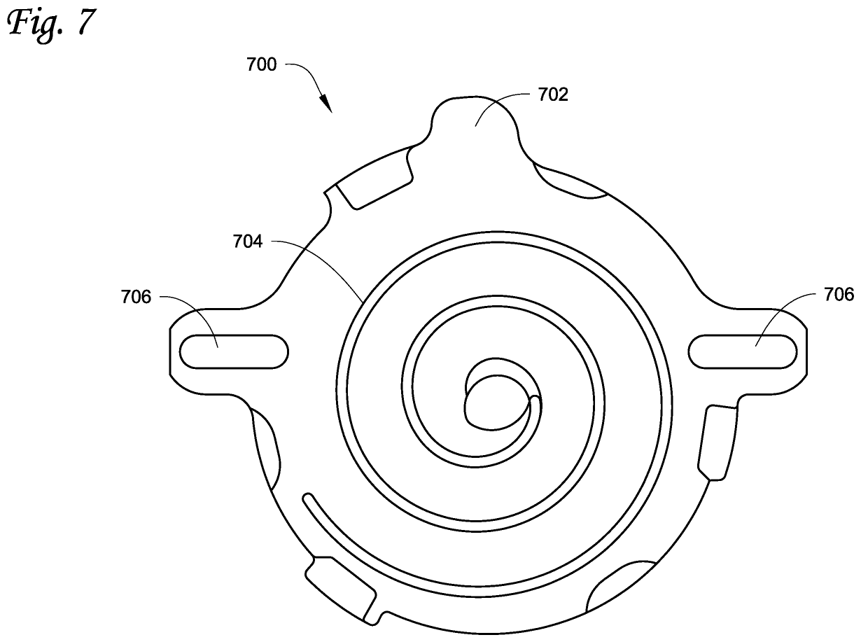

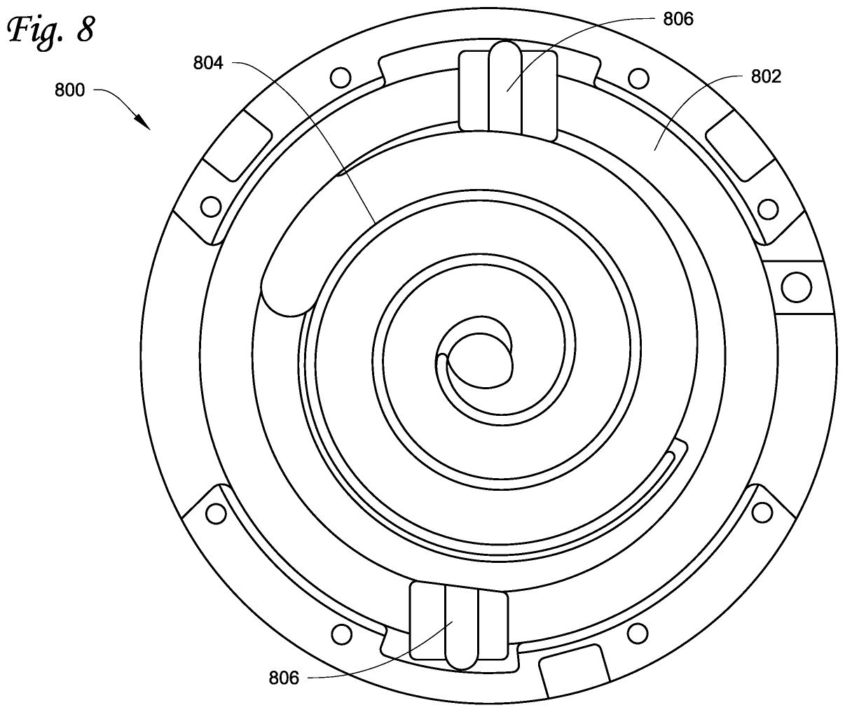

FIG. 6 shows an Oldham coupling for a scroll compressor according to an embodiment. Oldham coupling 600 includes coupling body 602, orbiting scroll-side projections 604, fixed scroll-side projections 606. When the scroll compressor including Oldham coupling 600 is assembled, surfaces of the orbiting scroll-side projections 604 can be located within grooves provided on the orbiting scroll, such as that shown in FIG. 7 and described below. When the scroll compressor includes an Oldham coupling, surfaces of the fixed scroll-side projections 606 can be located within grooves provided on the fixed scroll, such as those shown in FIG. 8 and described below. During operation of the scroll compressor, each of the projections 604 and 606 slides within the respective groove. Either the surfaces of each of the projections or the surfaces of those respective grooves are laser hardened to a nominal depth between approximately at or about 0.4 and at or about 1.5 mm. The laser hardening can result in the laser-hardened region including martensitic structure. The laser-hardened region can have a hardness of at least 400 HK. The laser-hardened region can contact a comparatively soft region, for example gray iron or any other suitable relatively soft material at the surface. The comparatively soft region can include, for example, iron or steel having a primarily pearlitic structure, carbon, nickel, manganese phosphate, fluoropolymer coatings, and the like. The comparatively soft region can be the grooves in each of the fixed and orbiting scrolls when the projections 604 and 606 of the Oldham coupling 600 are hardened. The comparatively soft region can be the projections 604 and 606 of the Oldham coupling 600 when the surfaces of the respective grooves are the laser-hardened region.

FIG. 7 shows an orbiting scroll configured to be used with an Oldham coupling in a scroll compressor according to an embodiment. Orbiting scroll 700 includes face 702. Scroll 704 extends from face 702. In an embodiment, grooves 706 are provided at two positions on face 702. The grooves 706 are openings in the face 702 capable of receiving projections of an Oldham coupling, such as projections 604 described above and shown in FIG. 6. In an embodiment, the grooves 706 are laser hardened, and the projection of the Oldham coupling are comparatively soft. In an embodiment, the projections of the Oldham coupling are laser hardened, and the grooves 706 are comparatively soft. The laser hardening can result in the laser-hardened region including the martensitic structure. The laser-hardened region can have a hardness of at least 400 HK. The comparatively soft region can include, for example, primarily pearlitic structure, carbon, nickel, manganese phosphate, fluoropolymer coatings, and the like.

FIG. 8 shows a fixed scroll configured to be used with an Oldham coupling in a scroll compressor according to an embodiment. Fixed scroll 800 includes face 802. Scroll 804 extends from face 802. In an embodiment, grooves 806 are provided at two positions on face 802. The grooves 806 are openings in the face 802 capable of receiving projections of an Oldham coupling, such as projections 604 described above and shown in FIG. 6. In an embodiment, the grooves 806 are laser hardened, and the projection of the Oldham coupling are comparatively soft. In an embodiment, the projections of the Oldham coupling are laser hardened, and the grooves 806 are comparatively soft. The laser hardening can result in the laser-hardened region including martensitic structure. The laser-hardened region can have a hardness of at least 400 HK. The comparatively soft region can include, for example, primarily pearlitic structure, carbon, nickel, manganese phosphate, fluoropolymer coatings, and the like.

Aspects:

It is understood that any of aspects 1-6 can be combined with any of aspects 7-12 or 13-19. It is understood that any of aspects 7-12 can be combined with any of aspects 13-19

Aspect 1. A compressor, comprising:

a housing including a fixed scroll member;
an orbiting scroll member; and
a thrust bearing disposing between the housing and the orbiting scroll member on an axial direction of the orbiting scroll member,
wherein the thrust bearing has a first thrust plate with a first wearing surface and a second thrust plate with a second wearing surface opposing the first wearing surface, and
one of the wearing surfaces has a laser hardened layer including martensitic structure opposing the other one of the wearing surfaces.

Aspect 2. The compressor according to aspect 1, wherein the laser hardened layer including martensitic structure has a thickness of between at or about 0.4 mm and at or about 1.5 mm with the one of the wearing surfaces having the laser hardened layer including martensitic structure.

Aspect 3. The compressor according to any of aspects 1 or 2, wherein the laser hardened layer including martensitic structure has a hardness of at least 400 HK.

Aspect 4. The compressor according to any of aspects 1-3, wherein the other one of the wearing surfaces includes a pearlitic microstructure.

Aspect 5. The compressor according to any of aspects 1-4, wherein the first thrust plate is installed or integrated into the housing, and the second thrust plate is installed or integrated into the orbiting scroll member.

Aspect 6. The compressor according to any of aspects 1-5, wherein the wearing surfaces contact one other when the compressor is not in operation.

Aspect 7. An HAVCR system, comprising:

a compressor; a condenser; an expander; and an evaporator,
wherein the compressor comprises:
a housing including a fixed scroll member;
an orbiting scroll member; and
a thrust bearing disposing between the housing and the orbiting scroll member on an axial direction of the orbiting scroll member,
wherein the thrust bearing has a first thrust plate with a first wearing surface and a second thrust plate with a second wearing surface opposing the first wearing surface, and
wherein one of the wearing surfaces has a laser hardened layer including martensitic structure opposing the other one of the wearing surfaces.

Aspect 8. The HACVR system according to aspect 7, wherein the laser hardened layer including martensitic structure has a thickness of between at or about 0.4 mm and at or about 1.5 mm with the one of the wearing surfaces having the laser hardened layer including martensitic structure.

Aspect 9. The HACVR system according to any of aspect 7 or 8, wherein the laser hardened layer including martensitic structure has a hardness of at least 400 HK.

Aspect 10. The HACVR system according to any of aspects 7-9, wherein the other one of the wearing surfaces includes a pearlitic microstructure.

Aspect 11. The HACVR system according to any of aspects 7-10, wherein the first thrust plate is installed or integrated into the housing, and the second thrust plate is installed or integrated into the orbiting scroll member.

Aspect 12. The HACVR system according to any of aspects 7-11, wherein the wearing surfaces contact one other when the compressor is not in operation.

Aspect 13. A method of manufacturing a wearing resistant thrust bearing of a compressor, compressing:

providing a housing including a stationary supporting structure with a first thrust plate and a first wearing surface of a thrust bearing;
providing an orbiting scroll member with a second thrust plate and a second wearing surface of the thrust bearing positioned opposing the first wearing surface when the compressor is assembled; laser treating a one of the wearing surfaces;
quenching the one of the wearing surfaces by a mass of the thrust plate of which the one of the wearing surfaces that is treated with laser;
producing a laser hardened layer including martensitic structure opposing the other one of the wearing surfaces;
tempering the thrust plate of which the one of the wearing surfaces is treated with laser; and assembling the stationary supporting structure and the orbiting scroll member so that the first wearing surface of the first thrust plate opposes the second wearing surface of the second thrust plate forming the thrust bearing between the stationary supporting structure and the orbiting scroll member of the compressor.

Aspect 14. The method according to aspect 13, wherein the laser hardened layer including martensitic structure has a thickness of between at or about 0.4 mm and at or about 1.5 mm with the one of the wearing surfaces having the laser hardened layer including martensitic structure.

Aspect 15. The method according to any of aspects 13 or 14, wherein the laser hardened layer including martensitic structure has a hardness of at least 400 HK.

Aspect 16. The method according to any of aspects 13-15, further comprising:

measuring the hardness of the laser hardened layer including martensitic structure using an average of a plurality of readings.

Aspect 17. The method according to any of aspects 13-16, wherein the other one of the first and second wearing surfaces includes a pearlitic microstructure.

Aspect 18. The method according to any of aspects 13-17, wherein the first thrust plate is installed or integrated into the stationary supporting structure, and the second thrust plate is installed or integrated into the orbiting scroll member.

Aspect 19. The method according to any of aspects 13-18, wherein the first and second wearing surfaces contact one other when the compressor is not in operation.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A compressor, comprising:
a housing including a fixed scroll member;
an orbiting scroll member; and
a thrust bearing disposing between the housing and the orbiting scroll member on an axial direction of the orbiting scroll member,
wherein the thrust bearing has a first thrust plate with a first wearing surface and a second thrust plate with a second wearing surface opposing the first wearing surface, and one of the wearing surfaces has a laser hardened layer including martensitic structure opposing the other one of the wearing surfaces.

2. The compressor of claim 1, wherein the laser hardened layer including martensitic structure has a thickness of between at or about 0.4 mm and at or about 1.5 mm with the one of the wearing surfaces having the laser hardened layer including martensitic structure.

3. The compressor of claim 1, wherein the laser hardened layer including martensitic structure has a hardness of at least 400 HK.

4. The compressor of claim 1, wherein the other one of the wearing surfaces includes a pearlitic microstructure.

5. The compressor of claim 1, wherein the first thrust plate is installed or integrated into the housing, and the second thrust plate is installed or integrated into the orbiting scroll member.

6. The compressor of claim 1, wherein the wearing surfaces contact one other when the compressor is not in operation.

7. An HAVCR system, comprising:
a compressor; a condenser; an expander; and an evaporator,
wherein the compressor comprises:
a housing including a fixed scroll member;
an orbiting scroll member; and
a thrust bearing disposing between the housing and the orbiting scroll member on an axial direction of the orbiting scroll member,
wherein the thrust bearing has a first thrust plate with a first wearing surface and a second thrust plate with a second wearing surface opposing the first wearing surface, and
wherein one of the wearing surfaces has a laser hardened layer including martensitic structure opposing the other one of the wearing surfaces.

8. The HACVR system of claim 7, wherein the laser hardened layer including martensitic structure has a thickness of between at or about 0.4 mm and at or about 1.5 mm with the one of the wearing surfaces having the laser hardened layer including martensitic structure.

9. The HACVR system of claim 7, wherein the laser hardened layer including martensitic structure has a hardness of at least 400 HK.

10. The HACVR system of claim 7, wherein the other one of the wearing surfaces includes a pearlitic microstructure.

11. The HACVR system of claim 7, wherein the first thrust plate is installed or integrated into the housing, and the second thrust plate is installed or integrated into the orbiting scroll member.

12. The HACVR system of claim 7, wherein the wearing surfaces contact one other when the compressor is not in operation.

13. A method of manufacturing a scroll compressor with a wearing resistant thrust bearing, compressing:
providing a housing including a stationary supporting structure with a first thrust plate and a first wearing surface of a thrust bearing;
providing an orbiting scroll member with a second thrust plate and a second wearing surface of the thrust bearing positioned opposing the first wearing surface when the compressor is assembled;
laser treating a one of the wearing surfaces;
quenching the one of the wearing surfaces by a mass of the thrust plate of which the one of the wearing surfaces that is treated with laser;
producing a laser hardened layer including martensitic structure opposing the other one of the wearing surfaces;
tempering the thrust plate of which the one of the wearing surfaces is treated with laser; and
assembling the stationary supporting structure and the orbiting scroll member so that the first wearing surface of the first thrust plate opposes the second wearing surface of the second thrust plate forming the thrust bearing between the stationary supporting structure and the orbiting scroll member of the compressor.

14. The method of claim 13, wherein the laser hardened layer including martensitic structure has a thickness of between at or about 0.4 mm and at or about 1.5 mm with the one of the wearing surfaces having the laser hardened layer including martensitic structure.

15. The method of claim 13, wherein the laser hardened layer including martensitic structure has a hardness of at least 400 HK.

16. The method of claim 13, further comprising:
measuring the hardness of the laser hardened layer including martensitic structure using an average of a plurality of readings.

17. The method of claim 13, wherein the other of the wearing surfaces includes a pearlitic microstructure.

18. The method of claim 13, wherein the first thrust plate is installed or integrated into the housing, and the second thrust plate is installed or integrated into the orbiting scroll member.

19. The method of claim 13, wherein the wearing surfaces contact one other when the compressor is not in operation.
